(19) United States
(12) Patent Application Publication
(10) Pub. No.: US 2024/0411199 A1
(43) Pub. Date: Dec. 12, 2024

(54) ELECTRO-OPTIC MODULATOR

(71) Applicant: Semtech Corporation, Camarillo, CA (US)

(72) Inventors: Zhao WANG, Ottawa (CA); Yew Hoe NG, Braintree (GB)

(21) Appl. No.: 18/330,126

(22) Filed: Jun. 6, 2023

(51) Int. Cl. G02F 1/21; G02F 1/225

(52) U.S. Cl. CPC G02F 1/212; G02F 1/2257

(57) ABSTRACT

This application relates to a travelling wave electro-optic modulator die comprising a signal carrying structure and a shielding structure. The signal carrying structure is configured to provide an electric field to modulate an optical path length of an optical waveguide. The shielding structure comprises a first shielding electrode and a second shielding electrode located on opposing sides of the signal carrying structure and at least one connecting portion electrically coupled to the first shielding electrode and the second shielding electrode.

### TECHNICAL FIELD

The present disclosure is related to apparatus for modulating optical signals, in particular an electro-optic modulator die, such as a travelling wave electro-optic modulator die, or a travelling wave Mach-Zehnder modulator.

### BACKGROUND

Digital communication is widely used in a range of applications and, in at least some digital communication systems, a transmitter may be arranged to transmit data over a communication channel to a receiver. In some examples a transmitter and a receiver may be a single component, such as a single chip or die, referred to as a transceiver.

The communication channel may comprise some physical medium such as a suitable waveguide, e.g. a transmission line for electrical data transmission or an optical fibre for optical data transmission, or the communication channel may be a free space channel for radio frequency transmission or the like. The transmitter may include a modulator for generating a modulated signal based on the data, where the modulated signal comprises a stream of symbols representing the data according to a desired transmission format, and the receiver may receive and demodulate the modulated signal.

In some instances, each symbol may represent a single bit, e.g. the modulator may modulate some physical property to take one of two different states to represent the value of a single bit of data. For example, within each symbol period the signal level of the modulated signal may be modulated to one or two defined levels to represent the relevant value of one bit of data. In at least some applications, however, especially where relatively high rates of data transmission are preferred, the modulated signal may be generated so that each symbol represents multiple bits, for example two bits could be encoded by modulating the signal level to adopt an appropriate one of four different states.

In an optical system, the modulator may modulate a property of optical radiation, such as the amplitude or intensity of the radiation. This may be achieved by varying an optical path length of an optical waveguide to cause constructive and/or destructive interference of optical radiation propagating through the waveguide. For example, optical radiation may propagate along one or more optical waveguides and the optical path length of one or more of the optical waveguides may be varied and the radiation from the waveguides may be combined causing the radiation from different waveguides to interfere constructively or destructively depending on the relative path lengths traversed by radiation in the different waveguides. The path length difference may be induced by physically manipulating the waveguide, for example by applying a force to the waveguide, by applying a field, such as an electric field, or by applying an electrical potential to the waveguide. A travelling wave Mach-Zehnder modulator is an example of such a modulator.

A travelling wave optical modulator may be characterised by parameters known as ‘s-parameters’. One such parameter is EO (electro-optic) S-21, which is related to insertion loss of the modulator, and is a forward transmission parameter coefficient describing the relation between radiation input to the modulator and radiation output from the modulator. EO S-21 may be based on the electrical power input (for example measured using a vector network analyser (VNA)) and electrical power output, measured, for example, using photodetection to determine the optical power output and converting the optical power to electrical power. The insertion loss may be a measure of the power of radiation output from the modulator relative to the power of radiation input to the modulator. Insertion loss may be measured in decibels (dB) and may be determined according to the equation IL=10log₁₀P₀/Pᵢ, wherein Pᵢ is the input power and P₀ is the output power.

Another parameter which may be determined is EE (electric-electric) S-21, which is similar to the EO S-21 parameter, however both input and output electrical power is measured, for example using a VNA.

Another s-parameter is EE S-11, which is related to return loss of the modulator, describes reflected power within the modulator. For example, the return loss may describe the reflected electrical power relative to the input electrical power. Return loss may be measured in decibels (dB) and may be determined according to the equation

$$RL = 10 {log}_{10} \frac{{P}_{r}}{{P}_{i}} ,$$

wherein Pᵢ is the incident power and Pᵣ is the reflected power.

In some optical modulators, it may be advantageous for the modulator to have a low insertion loss (i.e. less negative when measured in dB) and low return loss (i.e. more negative when measured in dB) which indicates most of the incident radiation is transmitted rather than reflected.

It may also be advantageous for a modulator to operate over a range of input signal frequencies. Therefore, it may be advantageous for the modulator to have low insertion loss and low return loss over a wide range of input signal frequencies, in other words to have a wide bandwidth.

### SUMMARY

Embodiments of the present disclosure relate to apparatus and methods, in particular to an electro-optic modulator die, a travelling wave electro-optic modulator die and a travelling wave Mach-Zehnder modulator.

According to some embodiments there is provided a travelling wave electro-optic modulator die comprising a signal carrying structure configured to provide an electric field to modulate an optical path length of an optical waveguide. The travelling wave electro-optic modulator die further comprises a shielding structure, wherein the shielding structure comprises a first shielding electrode and a second shielding electrode located on opposing sides of the signal carrying structure and at least one connecting portion electrically coupled to the first shielding electrode and the second shielding electrode.

In some examples, the first shielding electrode may be a first ground electrode and the second shielding electrode may be a second ground electrode.

In some examples, the signal carrying structure may comprise a first signal electrode proximate to a first portion of the optical waveguide and a second signal electrode proximate to a second portion of the optical waveguide. For example, in some examples the signal carrying structure comprises a first signal electrode electrically coupled to a first junction comprising a first portion of the optical waveguide and a second signal electrode electrically coupled to a second junction comprising a second portion of the optical waveguide.

In some examples, the travelling wave electro-optic modulator die further comprises an optical splitter to split an optical input of the optical waveguide between the first portion of the optical waveguide parallel to the first signal electrode and the second portion of the optical waveguide parallel to the second signal electrode, and the modulated optical path length is a path length difference between the first portion of the optical waveguide and the second portion of the optical waveguide.

In some examples, each of the first signal electrode, second signal electrode, first shielding electrode and second shielding electrode may be elongate, parallel structures. The at least one connecting portion may extend substantially perpendicular to the first and second shielding electrodes.

In some examples, the at least one connecting portion may comprise a plurality of connecting portions electrically coupled to the first shielding electrode and the second shielding electrode.

In some examples, the travelling wave electro-optic modulator die may comprise at least 5 connecting portions and, in some examples, the travelling wave electro-optic modulator die may comprise at least 11 connecting portions.

In some examples, the shielding structure may be formed in at least one metal layer of the travelling wave electro-optic modulator die.

In some examples, the at least one connecting portion may have a dimension parallel to the first and second shielding electrodes of 200 μm or less, or 60 μm or less.

In some examples, the travelling wave electro-optic modulator die is a Mach-Zehnder modulator.

In another aspect, there is provided an electro-optic modulator die comprising a first shielding electrode and a second shielding electrode. The electro-optic modulator die further comprises a signal carrying structure located between the first and second shielding electrodes and configured to provide an electric field to modulate an optical path length of an optical waveguide. The electro-optic modulator die further comprises at least one conductive connecting portion electrically coupled to the first shielding electrode and the second shielding electrode.

In some examples, the at least one conductive connecting portion, the first shielding electrode and the second shielding electrode are formed at least partially in a common layer of the electro-optic modulator die. In some examples the common layer is a metal layer.

In some examples the electro-optic modulator die comprises a plurality of conductive connecting portions.

In some examples the signal carrying structure comprises a first signal electrode and a second signal electrode, wherein each of the first signal electrode, second signal electrode, first shielding electrode and second shielding electrode are elongate, parallel structures, and wherein the at least one connecting portion extends substantially perpendicular to the first and second shielding electrodes.

In some examples the optical waveguide comprises a PN junction or a PIN junction.

In another aspect, there is provided a travelling wave Mach-Zehnder modulator comprising an electro-optic modulator die. The electro-optic modulator die comprises a signal carrying structure and a shielding structure. The signal carrying structure comprises a first signal electrode and a second signal electrode, wherein the signal carrying structure configured to provide an electric field to modulate an optical path length of an optical waveguide. The shielding structure comprises a first ground electrode, a second ground electrode and a plurality of connecting portions, wherein the first ground electrode and the second ground electrode are located on opposing sides of the signal carrying structure and wherein each connecting portion is electrically conductive and coupled to the first ground electrode and to the second ground electrode.

In some examples the travelling wave Mach-Zehnder modulator comprises the optical waveguide, wherein the first signal electrode is electrically coupled to a first PN or PIN junction comprising a first portion of the optical waveguide and the second signal electrode is electrically coupled to a second PN or PIN junction comprising a second portion of the optical waveguide.

In some examples the connecting portions, the first ground electrode and the second ground electrode are at least partially formed in a common metal layer of the electro-optic modulator die.

In some examples, the plurality of connecting portions may have a dimension parallel to the first and second shielding electrodes of 200 μm or less, or 60 μm or less.

Unless otherwise indicated to the contrary, any of the features of any of the embodiments described herein may, where compatible, be implemented together with any one or more of the other features of the embodiments.

### BRIEF DESCRIPTION OF THE DRAWINGS

To better explain various embodiments and examples of the present disclosure and the principles, example implementation and operation thereof, reference will now be made, by way of example, to the following drawings, in which:

FIG. 1A illustrates a plan view of a prior art travelling wave electro-optic modulator die;

FIG. 1B illustrates a cross-sectional view of a prior art travelling wave electro-optic modulator die;

FIG. 2A illustrates a plan view of a travelling wave electro-optic modulator die;

FIGS. 2B and 2C illustrate cross-sectional views of a travelling wave electro-optic modulator die;

FIGS. 3A, 4A, 5A, 6A and 7A illustrate example shielding structures of a travelling wave electro-optic modulator die;

FIGS. 3B, 4B, 5B, 6B and 7B are graphs showing EE S-21 parameters of travelling wave electro-optic modulator dies with different shielding structures; and

FIGS. 8A and 8B are graphs showing the return loss of travelling wave electro-optic modulator dies with different shielding structures.

### DETAILED DESCRIPTION

Embodiments of the present disclosure relate to an electro-optic modulator die, for example a travelling wave electro-optic modulator die or a travelling wave Mach-Zehnder modulator.

In at least some communication systems, data may be transmitted over a communication channel as a series of symbols, where each symbol represents two or more bits of data. For example, data may be transmitted by modulating properties of a transmit signal based on groups of bits. As discussed above the signal may be transmitted by modulating the intensity of optical radiation using a modulator, such as an electro-optic modulator. An electro-optic modulator may utilise a change in refractive index of a waveguide, in response to an applied electric potential, to modulate an intensity of optical radiation. For example, a semiconductor junction, such as a PIN junction (formed from p-type, intrinsic and n-type material) or a PN junction (formed from p-type and n-type material) may form the waveguide and the refractive index of the waveguide may be varied by varying a biasing voltage across the junction. The potential bias applied to the junction may cause a change in free carrier concentration. Such an effect may be referred to as a plasma dispersion effect. In some examples the waveguide may be a silicon-on-insulator (SOI) waveguide.

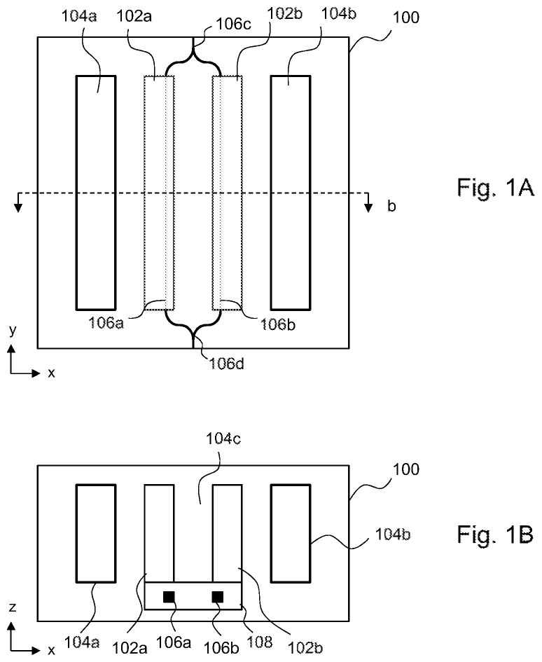

FIGS. 1A and 1B illustrate an example of prior art electro-optic modulator die 100. FIG. 1A shows a plan view of the electro-optic modulator die 100. FIG. 1B shows a cross-sectional view of the electro-optic modulator die 100 along the line ‘b’ indicated in FIG. 1A.

The electro-optic modulator die 100 comprises a signal carrying structure 102a, 102b configured to provide an electric field to modulate an optical path length of an optical waveguide 106. In this example the waveguide 106 is split into a first portion of the optical waveguide 106a and a second portion of the optical waveguide 106b at a first splitter 106c. The first and second waveguide portions are combined at a second splitter 106d. However, in other examples other configurations of waveguides may be used, for example fewer or more splitters and waveguide portions may be provided.

In this example the signal carrying structure 102a, 102b comprises a first signal electrode 102a and a second signal electrode 102b arranged to provide an electric field to modulate an optical path length of the first and second portions of the waveguide 106a, 106b respectively. In other examples more than two signal electrodes may be provided, in particular in examples where there are more than two portions of the waveguide.

In this example, when an electrical signal is applied to the signal carrying structure 102a, 102b an electric potential is applied to a junction portion 108 comprising the waveguide portions 106a, 106b. The junction portion 108 may comprise one or more PIN or PN junctions which form the waveguide portions 106a, 106b. For example, the junction portion 108 may comprise a first PN or PIN junction forming the first waveguide portion 106a and a second PN or PIN junction forming the second waveguide portion 106b. The first and second PN or PIN junctions may be “mirrored” junctions with a common central biasing electrode. For example, the junction portion 108 may comprise, from left to right in FIG. 1B, a first p-type portion, a n-type portion and a second p-type portion, wherein the junction formed by the first p-type portion and the n-type portion form the first waveguide and the junction formed by the n-type portion and the second p-type portion form the second waveguide. In some examples the waveguide portions 106a, 106b may be formed from NP junctions rather than PN junctions i.e. the junction portion 108 may comprise, from left to right, a first n-type portion, a p-type portion and a second n-type portion. In other examples, the junction portion may comprise PIN or NIP junctions, i.e. it may comprise, from left to right, it may comprise a first p-type portion, a first intrinsic portion, a n-type portion, a second intrinsic portion and a second p-type portion or it may comprise a first n-type portion, a first intrinsic portion, a p-type portion, a second intrinsic portion and a second n-type portion.

The junction portion may comprise a central biasing electrode, in order to bias the junctions, for example when the junctions are PN junctions and the junction portion comprises a first p-type portion, a n-type portion and a second p-type portion, the biasing electrode may connect to the n-type portion to allow a biasing voltage to be applied to the n-type portion of the junction. In other examples, the biasing electrode may connect to the appropriate central portion to allow the junctions to be correctly biased. The biasing voltage may be a DC voltage, e.g. 0V. The junction portion 108 may be formed from doped silicon, for example, using silicon-on-insulator (SOI) technology.

When the electric potential is applied to the junction portion 108 by the signal carrying structure, plasma dispersion effects cause a change in the optical path length of the waveguide portions. For example, if a voltage V₀ is applied to the first signal electrode 102a and a voltage of −V₀ is applied to the second signal electrode 102b then opposing electric potentials are applied to junctions associated with the first and second portions of the waveguide 106a, 106b. This may cause the optical path length of one portion of the waveguide to increase while the optical path length of the other portion of the waveguide may decrease, thereby causing a relative change in optical path length of the waveguide portions 106a, 106b.

In this example the first and second portions of the waveguide 106a, 106b are recombined at the second splitter 106d. When no voltage is applied to the signal carrying structure 102a, 102b the optical path lengths of the first and second portions of the waveguide 106a, 106b are nominally the same. Therefore, when the signal voltage is zero and the optical radiation from the first and second portions of the waveguide 106a, 106b are recombined at the second splitter 106d the optical radiation interferes constructively, and a relatively high optical output is output from the die 100. In contrast, when an appropriate voltage is applied the relative path lengths may be varied resulting in destructive interference, and a low optical output.

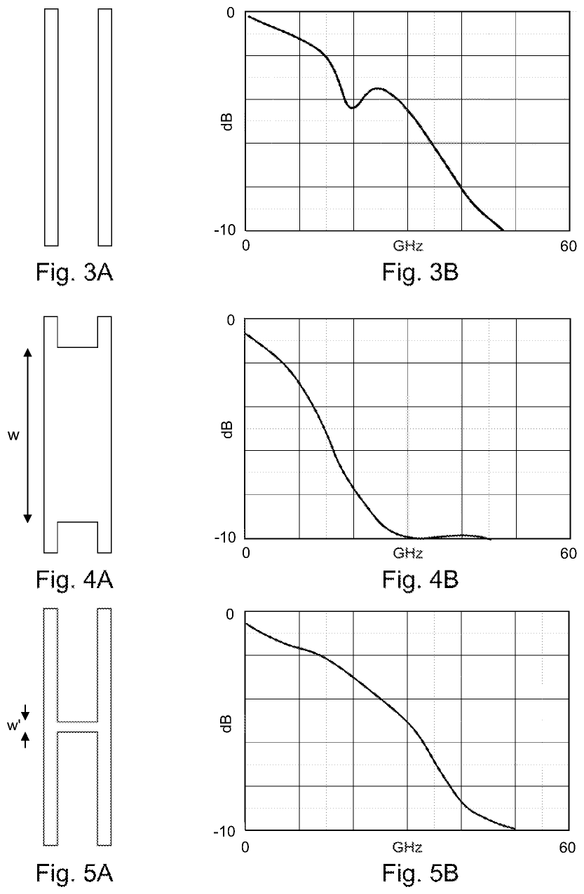

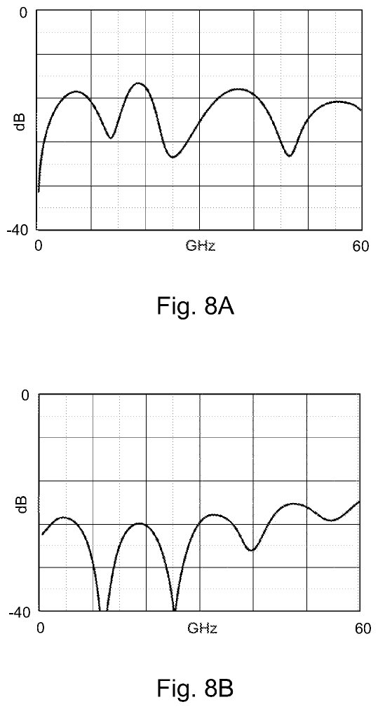

In some examples electro-optic modulator dies may comprise a shielding structure 104 which may provide a radio frequency shielding effect that reduces inter-channel crosstalk, and which may also lower the radio frequency (RF) propagation loss thereby resulting in a higher modulation bandwidth. Such a shielding structure may take the form of shielding electrodes 104a, 104b arranged on either side of the signal carrying structure 102a, 102b. For example, the shielding structure may comprise a first ground electrode and a second ground electrode arranged on opposing sides of the signal carrying structure 102a, 102b. As used herein, the “ground” refers to a reference potential from which other voltages in a system are measured, i.e. the ground electrodes may be maintained at a potential of 0V relative to other voltages in the system. However, such a shielding structure may suffer from ground imbalance issues due to differences in potential at the first and second shielding electrodes 104a, 104b which may result in reduced performance, for example, increased insertion loss and higher return loss, as described in relation to FIGS. 3A, 3B and 8A.

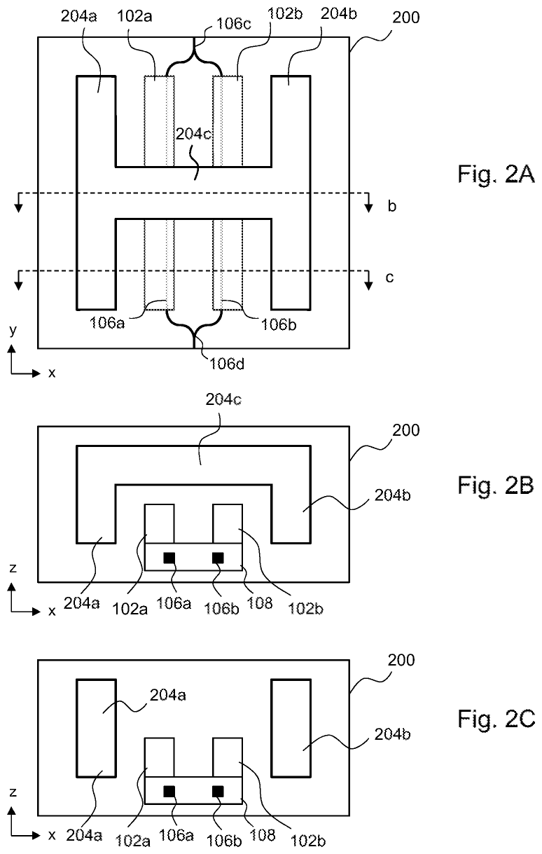

FIGS. 2A, 2B and 2C illustrate an example of a traveling wave electro-optic modulator die 200. FIG. 2A shows a plan view of the traveling wave electro-optic modulator die 200. FIG. 2B shows a cross-sectional view of the traveling wave electro-optic modulator die 200 along the line ‘b’ indicated in FIG. 2A. FIG. 2C shows a cross-sectional view of the traveling wave electro-optic modulator die 200 along the line ‘c’ shown in FIG. 2A.

The traveling wave electro-optic modulator die 200 comprises a signal carrying structure 102a, 102b, an optical waveguide 106 (including a first portion of the optical waveguide 106a, a second portion of the optical waveguide 106b, a first splitter 106c and a second splitter 106d) and a junction portion 108 as described in relation to FIGS. 1A and 1B.

The traveling wave electro-optic modulator die 200 shown in FIGS. 2A, 2B and 2C comprises a shielding structure comprising a first shielding electrode 204a and a second shielding electrode 204b located on opposing sides of the signal carrying structure 102a, 102b as described in relation to FIGS. 1A and 1B. However, the shielding structure of the traveling wave electro-optic modulator die 200 further comprises a connecting portion 204c electrically coupled to the first shielding electrode 204a and the second shielding electrode 204b. In this example there is one connecting portion 204c, however, in some examples the shielding structure may comprise more than one connecting portion 204c. The connecting portion 204c may be electrically conducting and provide an electrical connection between the first and second shielding electrodes 204a, 204b, thereby reducing potential imbalances between the first and second shielding electrodes 204a, 204b. Therefore, a traveling wave electro-optic modulator die 200 comprising a shielding structure with a connecting portion 204c may provide improved performance relative to a traveling wave electro-optic modulator die 200 which does not comprise a connecting portion 204c.

In this example the signal carrying structure comprises a first signal electrode 102a proximate to a first portion of the optical waveguide 106a and a second signal electrode 102b proximate to a second portion of the optical waveguide 106b. However, in other examples, there may be a different number of signal electrodes. For example, the traveling wave electro-optic modulator die 200 may comprise more than two signal electrodes.

Although not shown in the Figures, the traveling wave electro-optic modulator die 200 may be formed from a series of layers. For example, successive layers of material may be deposited on a substrate, such as silicon or a compound semiconductor material. Layers may be deposited using techniques such as atomic layer deposition (ALD), chemical vapour deposition (CVD), epitaxy, physical vapour deposition (PVD), spin coating or any other suitable method. Each layer may be selectively deposited in a desired pattern or may be deposited substantially covering the substrate or the preceding layer. When a layer is deposited to substantially cover the substrate or the preceding layer a portion of that layer may be selectively removed to form a desired pattern, for example by patterning the layer using photolithography and removing a portion of the layer to form the desired pattern, for example using a technique such as dry plasma etching, wet chemical etching or any other suitable method.

For example, the waveguide may be formed in a silicon layer of a silicon-on-insulator device. An insulating layer, such as silicon dioxide, may be deposited on a substrate such as a silicon substrate and the waveguide formed in a silicon layer deposited over the insulating layer. In some examples the signal carrying structure 102a, 102b and the shielding structure 204 may be formed in conductive layers. For example, they may be formed in metal layers of the traveling wave electro-optic modulator die 200. In this example, the shielding structure 204 is formed in at least one metal layer of the traveling wave electro-optic modulator die 200, however, in other examples the shielding structure 204 may be formed in any number of layers formed of any suitable conductive material. By providing the shielding structure entirely within the traveling wave electro-optic modulator die 200 rather than partially outside of the die (e.g. using wire bonding) the shielding structure may be simpler and less costly to produce and may provide a travelling wave electro-optical modulator die with improved performance.

In this example, the signal carrying structure 102a, 102b and a lower portion of the shielding structure 204 may be formed in a common layer or layers. An upper portion of the shielding structure 204, including the connecting portion 204c may be formed in a different common layer or layers deposited on top of the layer(s) forming the lower portion of the shielding structure 204 and the signal carrying structure 102a, 102b. The layers may be connected by one or more vias to provide electrical connection between the layers.

In some examples the connecting portion 204c may be formed at least partially concurrently with the first and second shielding electrodes 204a, 204b. For example, at least a portion of each of the first shielding electrode 204a, the second shielding electrode 204b and the connecting portion 204c are formed in a common layer. In some examples the first and second shielding electrodes 204a, 204b may be formed by selectively depositing or depositing and patterning a first conductive layer over a substrate (either directly on the substrate on another layer or layers deposited on the substrate). In this example the connecting portion 204c is formed in the same layer as an upper portion of first and second shielding electrodes 204a, 204b (e.g. a top metal layer). However, in other examples the connecting portion 204c may be formed in another layer (e.g. another metal layer, such as an intermediate metal layer).

To form the travelling wave electro-optic modulator die 200 a second conductive layer may then be selectively deposited or deposited and patterned over the first conductive layer to form a part of the shielding electrodes 204a, 204b. The second conductive layer may be deposited either directly on the first conductive layer on another layer or layers deposited on the first conductive layer.

A third conductive layer may then be selectively deposited or deposited and patterned over the second conductive layer to form a further part of the shielding electrodes 204a, 204b. The third conductive layer may be deposited either directly on the second conductive layer on another layer or layers deposited on the second conductive layer. When there are other layers between the second and third conductive layers, they may be electrically connected by one or more vias. The third conductive layer may also at least partially form the connecting portion 204c between the first and second shielding electrodes. However, in other examples the connecting portion 204c may be formed in another layer, provided it is electrically isolated from the signal electrodes 102a, 102b.

The signal electrodes 102a, 102b may be formed at least partially in the first and/or second conductive layers. The third conductive layer may then span over the first and/or second conductive layers to form the connecting portion of the shielding structure. The connecting portion of the shielding structure may be electrically isolated from the signal electrodes 102a, 102b below by depositing intervening insulating layers.

Although this example describes depositing three conductive layers, in other examples more or fewer conductive layers may be used to form the signal and shielding electrodes. For example, the second conductive layer described above may be optional.

Although not shown in the Figures, electrical connection pads may be provided for the signal carrying structure 102a, 102b and the shielding structure 204. For example, a first portion (or portions) of an upper layer forming the upper portion of the shielding structure 204, including the connecting portion 204c, may be electrically connected to the shielding structure 204 and exposed to form an electrical connection pad(s) to the shielding structure to allow an electrical connection, for example wire bonding. A second portion (or portions) of the upper layer, which is electrically isolated from the shielding structure 204, may be exposed to form an electrical connection pad(s) to the signal carrying structure. For example, a portion of the upper layer above an end of the signal carrying structure may form the electrical connection pad or provide connection to the electrical connection pad of the signal carrying structure 102 and may be connected to the signal carrying structure 102 by one or more vias. Multiple electrical connection pads may be provided for each if the signal carrying structure 102a, 102b and the shielding structure 204. In particular, in examples wherein the signal carrying structure comprises a first signal electrode 102a and a second signal electrode 102b at least one electrical connection pad may be provided for each signal electrode to allow a different signal voltage to be applied to each signal electrode 102a, 102b.

In some examples the first shielding electrode 204a is a first ground electrode the second shielding electrode 204b is a second ground electrode. In other words, the first and second shielding electrodes 204a, 204b may be maintained at a potential of 0V.

In this example each of the first signal electrode 102a, second signal electrode 102b, first shielding electrode 204a and second shielding electrode 204b are elongate, parallel structures and the connecting portion 204c extends substantially perpendicular to the first and second shielding electrodes 204a, 204b. Therefore, as can be seen in FIG. 2A the first shielding electrode 204a, second shielding electrode 204b and connecting portion 204c form a substantially ‘H-shaped’ structure when viewed in plan view. In other examples the electrodes and connecting portion 204c may be arranged in a different shape, provided the connecting portion 204c forms an electrical connection between the first and second shielding electrodes 204a, 204b.

In this example the traveling wave electro-optic modulator die 200 comprises a first optical splitter 106c to split an optical input of the optical waveguide between the first portion of the optical waveguide 106a parallel to the first signal electrode 102a and the second portion of the optical waveguide 106b parallel to the second signal electrode 102b, and the modulated optical path length is a path length difference between the first portion of the optical waveguide 106a and the second portion of the optical waveguide 106b. However, in other examples other arrangements of signal electrodes and waveguides may be provided. For example, there may be fewer or more waveguide portions and/or signal electrodes. Furthermore, their shape and relative positions may vary.

In some examples the traveling wave electro-optic modulator die 200 is a travelling wave Mach-Zehnder modulator die.

Each of the first and second signal electrodes 102a, 102b may have a width (i.e. dimension in the x direction) of 30 μm. The distance in the x direction between the first shielding electrode 204a and the first signal electrode 102a and between the second shielding electrode 204b and the second signal electrode 102b may be 50 μm. The distance in the x direction between the first shielding electrode 204a and the second shielding electrode 204b may be 190 μm. In other examples, the components of the traveling wave electro-optic modulator die 200 may have different dimensions.

FIGS. 2A, 2B and 2C show the traveling wave electro-optic modulator die 200 in isolation, however the traveling wave electro-optic modulator die 200 may be packaged, for example to provide ease of connection of electrical and optical inputs and outputs, and to protect the traveling wave electro-optic modulator die 200 from the environment (e.g. moisture, dust, physical damage, etc.). The traveling wave electro-optic modulator die 200 may be encapsulated in a suitable material and optical and electrical connections provided. For example, the traveling wave electro-optic modulator die 200 may be mounted on a lead frame and electrical connections may be made to the electrodes of the electrical connections by wire bonding to the lead frame.

FIG. 3A illustrates a plan view of a shielding structure of the electro-optic modulator die comprising a first shielding electrode and a second electrode described in relation to FIGS. 1A and 1B. The shielding structure of FIG. 3A does not comprise a connecting portion between the first and second shielding electrodes, but is otherwise similar to the shielding structure of the traveling wave electro-optic modulator die 200 described in relation to FIGS. 2A, 2B and 2C. As this shielding structure does not comprise a connecting portion, it is possible for a potential imbalance to form between the first and second shielding electrodes in use of the electro-optic modulator die.

In this example the width and spacing of the shielding electrodes and other components of the electro-optic modulator die are as described in relation to FIGS. 2A, 2B and 2C.

FIG. 3B shows a graph of insertion loss of the electro-optic modulator die described in relation to FIGS. 1A and 1B (i.e. comprising the shielding structure illustrated in FIG. 3A) over a range of input frequencies, wherein the input frequency is the frequency of a signal applied to a signal carrying structure of the electro-optic modulator die. The insertion loss generally increases (i.e. becomes more negative) as the input frequency increases. However, it can also be seen that there is a distinct ‘dip’ in the insertion loss at around 19.6 GHz. This dip results in reduced performance around this frequency. The −6 dB electrical bandwidth of an electro-optic modulator die comprising this shielding structure is 33.7 GHz. The insertion loss shown in this Figure, and the insertion losses and return losses shown in subsequent Figures are illustrative of a particular configuration of electro-optic modulator die and in practice may vary based on the features of a particular electro-optic modulator die. For example the insertion loss and return loss may vary with different lengths of die.

FIGS. 4A, 5A, 6A and 7A illustrate plan views of a shielding structures of an electro-optic modulator die comprising a first shielding electrode, a second electrode and at least one connecting portion. Other than the presence of the connecting portion, these shielding structures are similar to the shielding structure shown in FIG. 3A. FIGS. 4B, 5B, 6B and 7B show graphs of insertion loss of the shielding structures illustrated in FIGS. 4A, 5A, 6A and 7A respectively. It is noted that the insertion loss of the shielding structures with the connecting portion(s) do not suffer from the dip in insertion loss experienced by the shielding structure without the connecting portion. Therefore, providing a connecting portion between the first and second shielding electrodes may provide an improvement in insertion loss of an electro-optic modulator die.

FIG. 4A shows a shielding structure comprising a connecting portion with a dimension w in a direction parallel to the first and second shielding electrodes. In order to provide the connecting portion over the signal carrying structure, the signal carrying structure of a die comprising this shielding structure comprises one fewer conductive layer relative to the die comprising the shielding structure of the FIG. 3A. In this example w=1000 μm and the other dimensions the shielding structure and other components of the electro-optic modulator die are equal to those of the shielding structure of FIG. 3A.

FIG. 4B shows a graph of insertion loss of the shielding structure illustrated in FIG. 4A over a range of input frequencies. Although the dip in insertion loss is not present, this graph shows this shielding structure results in a relatively narrow bandwidth compared with the shielding structure of FIG. 3A. This shielding structure results in an electrical bandwidth of approximately 18 GHz at −6 dB.

In some examples the at least one connecting portion 204c connecting the first and second shielding electrodes 204a, 204b has a dimension, w, parallel to the first and second shielding electrodes of 200 μm or less. For example, the dimension, w, parallel to the first and second shielding electrodes is 60 μm or less, as illustrated in FIG. 5A.

FIG. 5A shows a shielding structure comprising a connecting portion with a dimension w′ in a direction parallel to the first and second shielding electrodes. In this example w′=60 μm and the other dimensions the shielding structure and other components of the electro-optic modulator die are equal to those of the shielding structure of FIG. 3A.

FIG. 5B shows a graph of insertion loss of the shielding structure illustrated in FIG. 5A over a range of input frequencies. The dip in insertion loss is also not present in this graph. Furthermore, the electrical bandwidth of this shielding structure is wider than that of the shielding structure shown in FIG. 4A, with electrical bandwidth of approximately 34.7 GHz at −6 dB, which compares favourably with the electrical bandwidth of the shielding structure shown in FIG. 3A. Over at least this range of dimensions a trend of increasing electrical bandwidth can be seen with decreasing dimension w. The dimension w may be selected based on this consideration and other considerations, for example the practical minimum size. However, in other examples the relationship between the dimension w and electrical bandwidth may vary, and therefore the dimension w may be selected based on a particular configuration of the electro-optic modulator die.

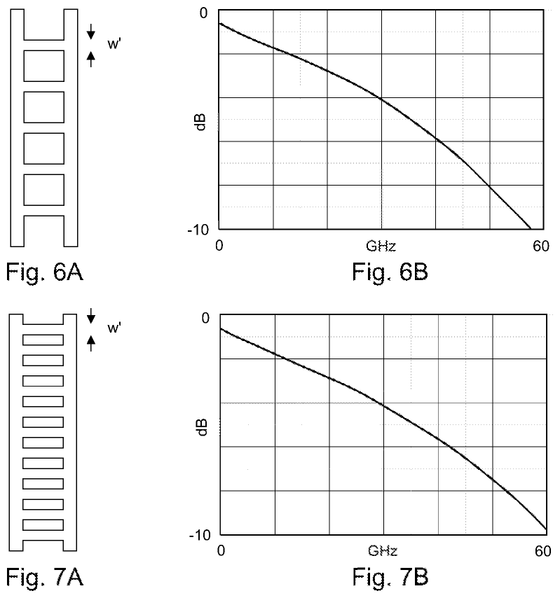

FIG. 6A shows a shielding structure comprising five connecting portions. Each connecting portion has a dimension w′ equal to that of the connecting portion shown in FIG. 5A i.e. each one has a dimension w′=60 μm. The other dimensions the shielding structure and other components of the electro-optic modulator die are equal to those of the shielding structure of FIG. 3A. In this example each connecting portion is perpendicular to the first and second shielding electrodes and they are regularly spaced along the length of the shielding structure.

FIG. 6B shows a graph of insertion loss of the shielding structure illustrated in FIG. 6A over a range of input frequencies. The dip in insertion loss is also not present in this graph. Furthermore, the electrical bandwidth of this shielding structure is wider than that of the previously described shielding structures, with electrical bandwidth of approximately 44.3 GHz at −6 dB.

FIG. 7A shows a shielding structure comprising eleven connecting portions. Each connecting portion has a dimension w′ equal to that of the connecting portion shown in FIGS. 5A and 6A i.e. each one has a dimension w′=60 μm. The other dimensions the shielding structure and other components of the electro-optic modulator die are equal to those of the shielding structure of FIG. 5A. In this example each connecting portion is perpendicular to the first and second shielding electrodes and they are regularly spaced along the length of the shielding structure.

FIG. 7B shows a graph of insertion loss of the shielding structure illustrated in FIG. 7A over a range of input frequencies. The dip in insertion loss is also not present in this graph. Furthermore, the electrical bandwidth of this shielding structure is wider than that of the previously described shielding structures, with electrical bandwidth of approximately 45.8 GHz at −6 dB.

In summary, the addition of a connecting portion or portions to the shielding structure may improve the performance of an electro-optic modulator die as can be seen by the lack of a dip in insertion loss as seen in comparison of FIG. 3B with the other graphs. Furthermore, a relatively thin connecting portion may provide a wider electrical bandwidth as can be seen in a comparison of FIGS. 4B and 5B. An even wider electrical bandwidth may be achieved by providing a plurality of connecting portions electrically coupled to the first shielding electrode and the second shielding electrode. For example, an electro-optic modulator die may comprise five connecting portions. In some examples the electro-optic modulator may comprise fewer or more than five connecting portions. In this example the electro-optic modulator die comprises eleven connecting portions, and in some examples the electro-optic modulator die may comprise more than eleven connecting portions. As can be seen in a comparison of FIGS. 5B, 6B and 7B, in some examples the electrical bandwidth may increase with an increasing number of connecting portions. However, in other examples the relationship between the number of connecting portions and electrical bandwidth may vary. Therefore, in some examples an optimal number of connecting portions may be determined based on a particular configuration of the electro-optic modulator die.

FIG. 8A is a graph showing return loss of an electro-optical modulator die comprising the shielding structure shown in FIG. 3A i.e. a shielding structure without a connecting portion. FIG. 8B is a graph showing return loss of an electro-optical modulator die comprising the shielding structure shown in FIG. 7A i.e. a shielding structure comprising eleven connecting portions each with a dimension w′=60 μm. As can be seen from a comparison of these graphs, the return loss is generally lower (i.e. more negative) in the graph of FIG. 8B. In other words, the return loss is also improved by the addition of connecting portion(s) between the first and second shielding electrodes.

It will be understood that the examples and embodiments described above are given by way of example only and those skilled in the art will understand that modifications, variations, additions or alterations may be made to specific embodiments described, or alternative embodiments may be implemented, without departing from the scope of the appended claims.

It should be noted that as used herein, unless expressly stated otherwise, the word “comprising” does not exclude the presence of other elements or steps other than those listed, references to an element or feature in the singular does not exclude the possibility of a plurality of such elements or features, and that recitation of different features or elements in the appended claims does not necessarily imply separate components; a single component or unit may fulfil the function of several elements recited in a claim. Any reference signs in the appended claims shall not be construed so as to limit their scope.

The features of any dependent claim may be combined with the features of any of the independent claims or other dependent claims.

1. A traveling wave electro-optic modulator die comprising:
a signal carrying structure configured to provide an electric field to modulate an optical path length of an optical waveguide; and
a shielding structure comprising:
a first shielding electrode and a second shielding electrode located on opposing sides of the signal carrying structure; and
at least one connecting portion electrically coupled to the first shielding electrode and the second shielding electrode.

2. The traveling wave electro-optic modulator die of claim 1, wherein the first shielding electrode is a first ground electrode the second shielding electrode is a second ground electrode.

3. The traveling wave electro-optic modulator die of claim 1, wherein the signal carrying structure comprises a first signal electrode electrically coupled to a first junction comprising a first portion of the optical waveguide and a second signal electrode electrically coupled to a second junction comprising a second portion of the optical waveguide.

4. The traveling wave electro-optic modulator die of claim 3 wherein the electro-optic modulator die further comprises an optical splitter to split an optical input of the optical waveguide between the first portion of the optical waveguide parallel to the first signal electrode and the second portion of the optical waveguide parallel to the second signal electrode, and the modulated optical path length is a path length difference between the first portion of the optical waveguide and the second portion of the optical waveguide.

5. The traveling wave electro-optic modulator die of claim 3 wherein each of the first signal electrode, second signal electrode, first shielding electrode and second shielding electrode are elongate, parallel structures and wherein the at least one connecting portion extends substantially perpendicular to the first and second shielding electrodes.

6. The traveling wave electro-optic modulator die of claim 1, wherein the at least one connecting portion comprises:
a plurality of connecting portions electrically coupled to the first shielding electrode and the second shielding electrode.

7. The traveling wave electro-optic modulator die of claim 6 comprising at least 5 connecting portions.

8. The traveling wave electro-optic modulator die of claim 7 comprising at least 11 connecting portions.

9. The traveling wave electro-optic modulator die of claim 1 wherein the shielding structure is formed in at least one metal layer of the electro-optic modulator die.

10. The traveling wave electro-optic modulator die of claim 1 wherein the at least one connecting portion has a dimension parallel to the first and second shielding electrodes of 200 μm or less.

11. The traveling wave electro-optic modulator die of claim 10 wherein the dimension parallel to the first and second shielding electrodes is 60 μm or less.

12. The traveling wave electro-optic modulator die of claim 1 wherein the electro-optic modulator die is a Mach-Zehnder modulator.

13. An electro-optic modulator die comprising:
a first shielding electrode and a second shielding electrode;
a signal carrying structure located between the first and second shielding electrodes and configured to provide an electric field to modulate an optical path length of an optical waveguide; and
at least one conductive connecting portion electrically coupled to the first shielding electrode and the second shielding electrode.

14. The electro-optic modulator die of claim 13 wherein the at least one conductive connecting portion, the first shielding electrode and the second shielding electrode are formed at least partially in a common layer of the electro-optic modulator die.

15. The electro-optic modulator die of claim 14 wherein the common layer is a metal layer.

16. The electro-optic modulator die of claim 13 wherein the electro-optic modulator die comprises a plurality of conductive connecting portions.

17. The electro-optic modulator die of claim 13,
wherein the signal carrying structure comprises a first signal electrode and a second signal electrode,
wherein each of the first signal electrode, second signal electrode, first shielding electrode and second shielding electrode are elongate, parallel structures, and
wherein the at least one connecting portion extends substantially perpendicular to the first and second shielding electrodes.

18. The electro-optic modulator die of claim 13 wherein the optical waveguide comprises a PN junction or a PIN junction.

19. A travelling wave Mach-Zehnder modulator comprising:
an electro-optic modulator die comprising:
a signal carrying structure comprising a first signal electrode and a second signal electrode, the signal carrying structure configured to provide an electric field to modulate an optical path length of an optical waveguide; and
a shielding structure comprising a first ground electrode, a second ground electrode and a plurality of connecting portions,
wherein the first ground electrode and the second ground electrode are located on opposing sides of the signal carrying structure; and
wherein each connecting portion is electrically conductive and coupled to the first ground electrode and to the second ground electrode.

20. The travelling wave Mach-Zehnder modulator of claim 19 comprising the optical waveguide,
wherein the first signal electrode is electrically coupled to a first PN or PIN junction comprising a first portion of the optical waveguide and the second signal electrode is electrically coupled to a second PN or PIN junction comprising a second portion of the optical waveguide.

21. The travelling wave Mach-Zehnder modulator of claim 19 wherein the connecting portions, the first ground electrode and the second ground electrode are at least partially formed in a common metal layer of the electro-optic modulator die.

22. The traveling wave electro-optic modulator die of claim 19 wherein the connecting portions have a dimension parallel to the first and second ground electrodes of 200 μm or less.

23. The traveling wave electro-optic modulator die of claim 22 wherein the dimension parallel to the first and second ground electrodes is 60 μm or less.
